(19) United States
(12) Patent Application Publication
(10) Pub. No.: US 2012/0298600 A1
(43) Pub. Date: Nov. 29, 2012

(54) REINFORCEMENT POST FOR PALLET RACK FRAME AND PALLET RACK FRAME INCORPORATING THE SAME

(75) Inventor: Peter L. McCarthy, Ancaster (CA)

(73) Assignee: THE ECONO-RACK GROUP INC., Oakville, ON (CA)

(21) Appl. No.: 13/513,796

(22) PCT Filed: Dec. 2, 2010
(86) PCT No.: PCT/CA10/01915

§ 371 Date: Aug. 14, 2012

Related U.S. Application Data
(60) Provisional application No. 61/265,869, filed on Dec. 2, 2009.

(51) Int. Cl. A47B 96/14; B23P 11/00; A47B 81/00

(52) U.S. Cl. 211/49.1; 248/351; 29/525.01

(57) ABSTRACT

A reinforcement post for a pallet rack frame, the reinforcement post being configured to be secured to a pallet rack frame post with fasteners.

### FIELD OF THE INVENTION

The present invention relates generally to pallet racks and in particular, to a reinforcement post for a pallet rack frame and to a pallet rack frame incorporating the same.

### BACKGROUND OF THE INVENTION

Pallet racks are commonly used in storage environments such as warehouses, manufacturing facilities, and “big box”-style retail stores for the storage of palletized loads. Pallet racks typically comprise a steel frame made up of vertical frame posts and several layers of horizontal beams that define vertically spaced shelves thereby to provide multi-level storage space for rows of palletized loads. The palletized loads are typically loaded individually into and out of the pallet rack by forklift trucks.

It is often required to reinforce the lower ends of the vertical frame posts of pallet racks to improve their impact resistance near the floor level and prevent damage caused by forklift trucks, for example. Additionally, structural load requirements can sometimes necessitate the reinforcement of the frame posts to increase the vertical load bearing capability of the frame posts, and thereby improve the capacity of the pallet racks. A common approach to reinforcing pallet rack frame posts is by “doubling up” the frame posts, as is shown in FIGS. 1 to 3. The “doubled up” configuration is achieved by welding duplicate frame posts 12 together in a front-to-back configuration, whereby the adjacent frame posts are joined solely by welds 14.

Other approaches for reinforcing pallet rack frame posts have also been considered. For example, U.S. Pat. No. 3,273,720 to Seiz discloses a channel member for a lower upright of a storage rack. The channel member has a tubular shape, and is sized to fit within the inner channel of the lower upright. Once inserted into the lower upright, the channel member is tack welded to the upright. Use of the welded channel member in this manner allows the structural integrity of the lower upright to be improved so that it may withstand greater vertical loads.

The publication entitled “Broken racks can break the bank”, Material Handling Management, vol. 62(7), page 45 (July 2007) authored by Boyer discloses a reinforcement post insert for a bolt-together pallet rack frame. The post insert is “C-shaped” and is sized to be welded to the interior of a frame post. The post insert renders the frame post more impact resistant at the front corners and sides, where the frame posts would otherwise be vulnerable to damage from lift-trucks.

Presently, the need for reinforcement posts is taken into consideration by the pallet rack manufacturer during the design phase of the pallet rack frame. Consequently, the dimensions of the reinforcement posts are typically customized to meet design needs and are therefore of non-standard size. The customized reinforcement posts are welded to the pallet rack frame posts by the pallet rack manufacturer prior to shipping. Owing to the complexity of the welding process, it is generally difficult and costly to add reinforcement posts to an assembled pallet rack in the field. Therefore, it is desired to provide an improved reinforcement post for a pallet rack having standard, non-customized dimensions, and which is not limited to installation by the manufacturer prior to shipping.

In view of the above, an improved reinforcement post for a pallet rack frame is disclosed herein.

### SUMMARY OF THE INVENTION

Accordingly, in one aspect there is provided a reinforcement post for a pallet rack frame, the reinforcement post being configured to be secured to a pallet rack frame post with fasteners.

In another aspect, there is provided a pallet rack frame comprising a plurality of pallet rack frame posts, a plurality of load beams connected to the frame posts for providing horizontal support of palletized loads, and at least one reinforcement post secured to a respective frame post with fasteners, the reinforcement post providing reinforcement to the frame post when secured thereto.

In still another aspect, there is provided a method of providing reinforcement for a pallet rack frame post comprising securing a reinforcement post to the frame post with fasteners.

### BRIEF DESCRIPTION OF THE DRAWINGS

Embodiments will now be described more fully with reference to the accompanying drawings in which:

FIG. 1 is a photographic view of a prior art reinforced pallet rack;

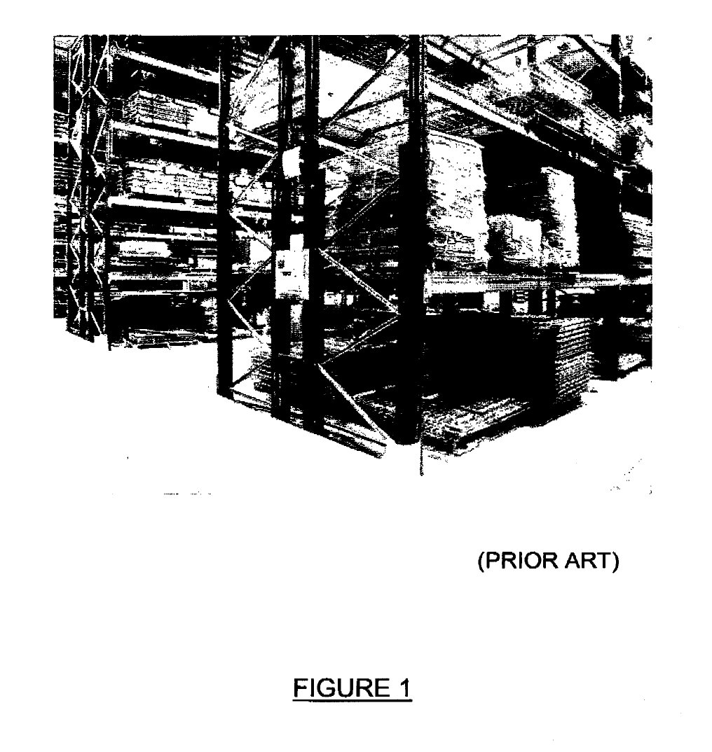

FIG. 2 is a top cross-sectional view of a prior art reinforced frame post forming part of the reinforced pallet rack of FIG. 1;

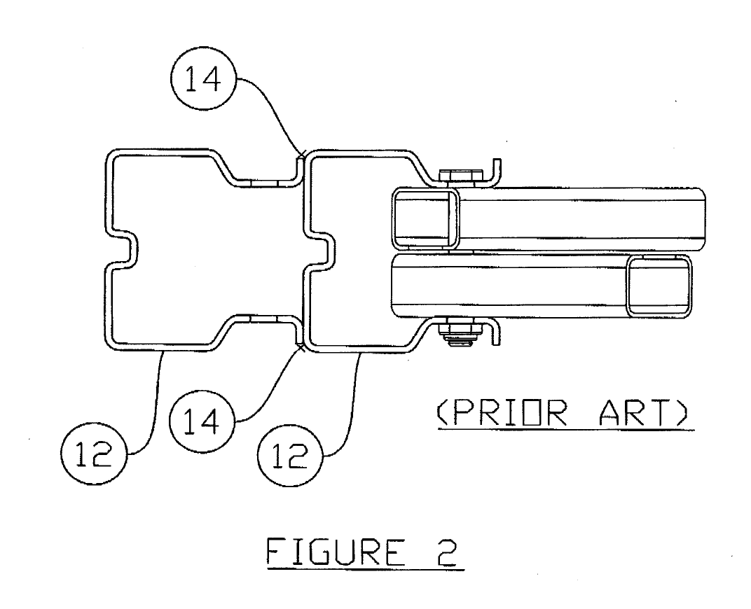

FIG. 3 is a side elevational view of the prior art reinforced frame post of FIG. 2;

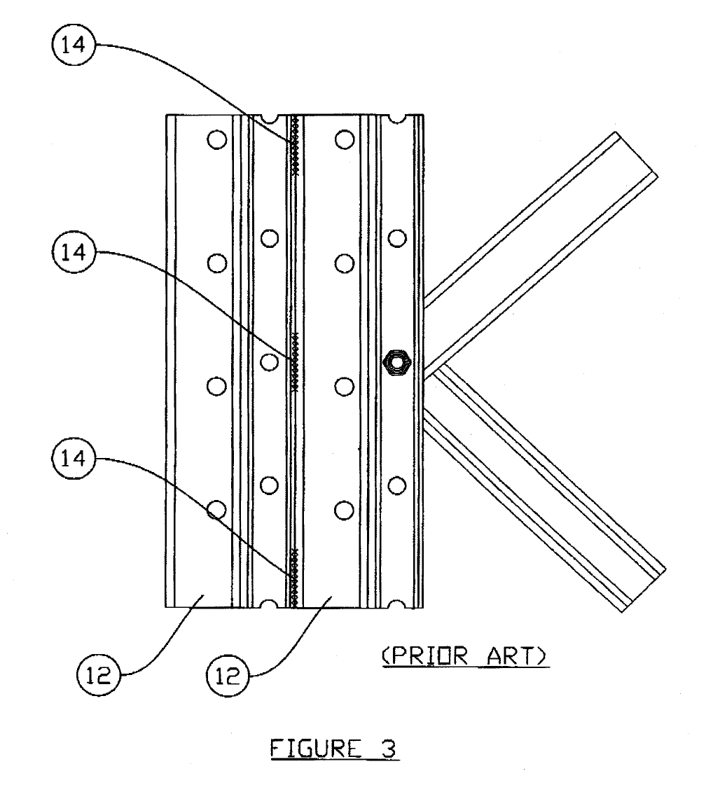

FIG. 4 is a perspective view of a pallet rack frame comprising reinforcement posts;

FIG. 5 is a top view of a reinforced frame post;

FIG. 6 is a rear perspective view of the reinforced frame post of FIG. 5; and

FIG. 7 is a front perspective view the reinforced frame post of FIG. 5.

### DETAILED DESCRIPTION OF THE EMBODIMENTS

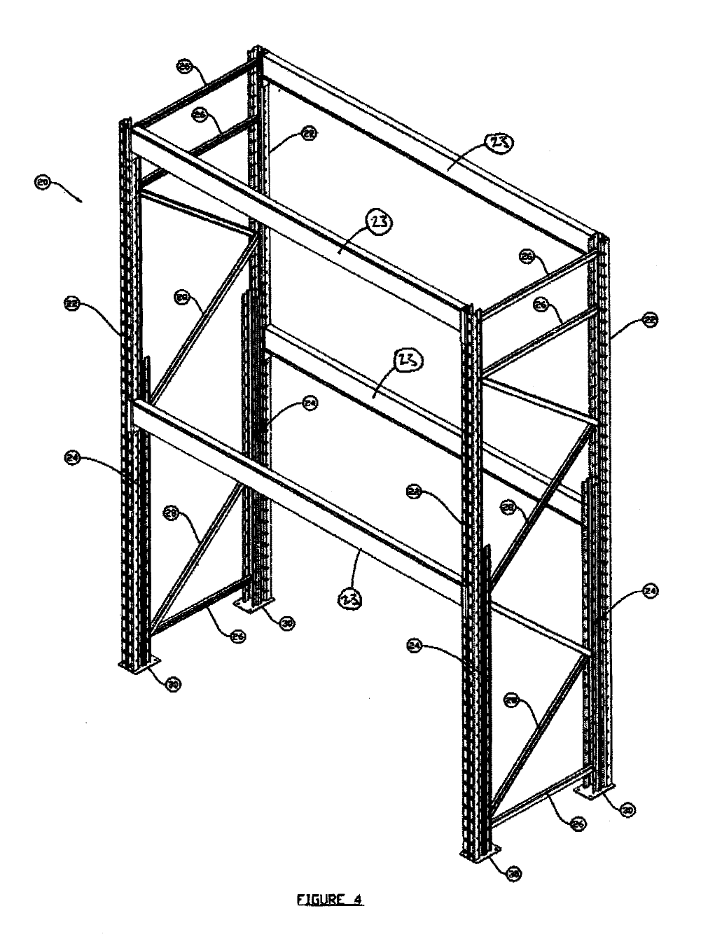

Turning now to FIG. 4, a pallet rack frame is shown and is generally identified by reference numeral 20. Pallet rack frame 20 comprises a plurality of vertical frame posts 22, each of which supports vertically spaced, horizontal load beams 23. Load beams 23 define vertically spaced shelves and provide surfaces onto which palletized loads may be placed. Each frame post 22 has a reinforcement post 24 secured to it by fasteners. The reinforcement posts 24 generally provide structural reinforcement to the frame posts 22, and increase both the load bearing capacity of frame posts 22, and the resilience of frame posts 22 to accidental lateral impact, such as from forklift trucks. Pallet rack frame 20 also comprises horizontal braces 26 and diagonal braces 28, which connect opposing frame posts 22 and reinforcing posts 24 together for providing horizontal stability within the pallet rack frame 20. At the base of each frame post and reinforcement post assembly is positioned a base plate 30, which is sized to support both the frame post and the reinforcement post to distribute load and to provide a stable footing.

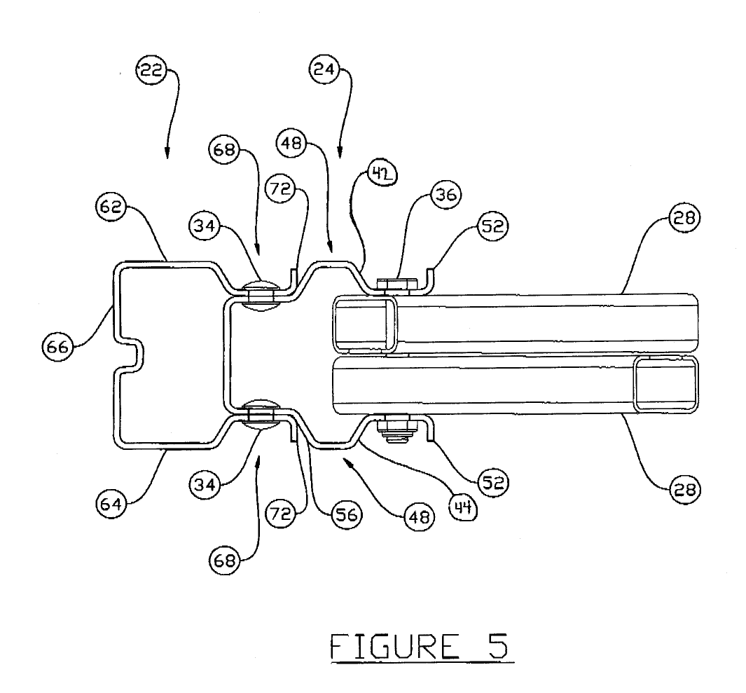

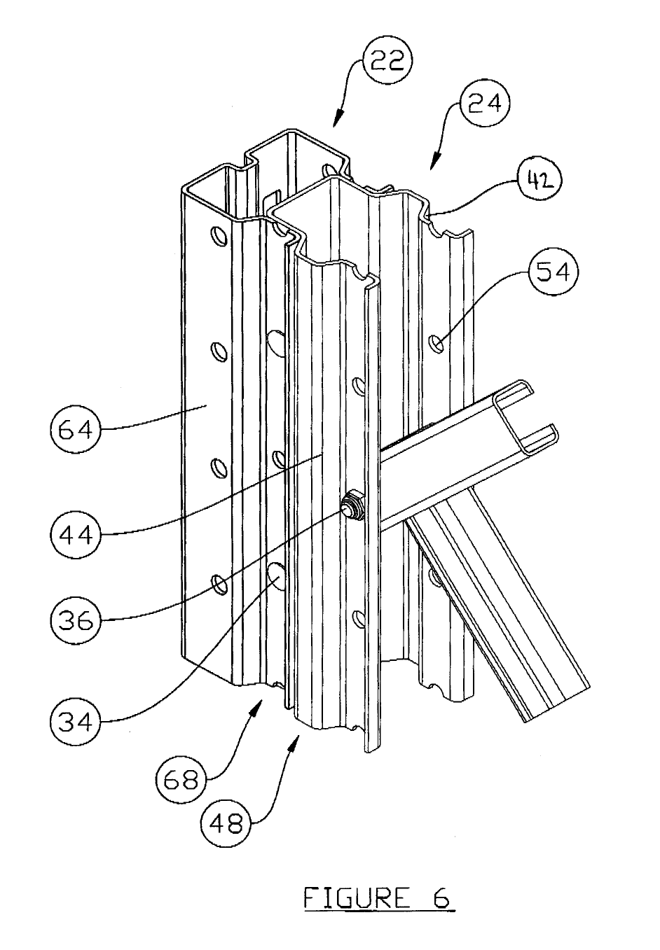

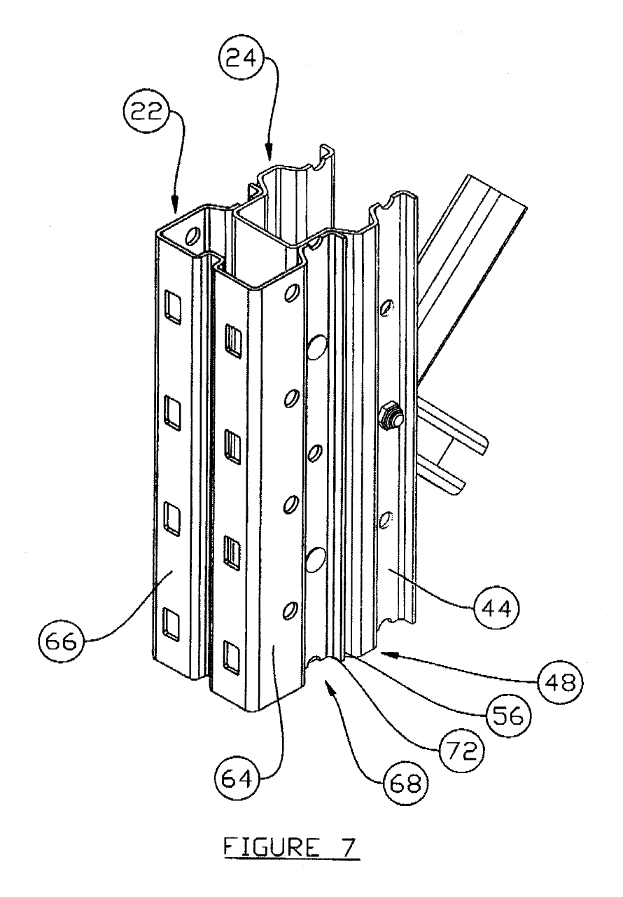

FIGS. 5 to 7 better illustrate the connection between one of the reinforcement posts 24 and its associated frame post 22 to form the frame post and reinforcement post assembly. As can be seen and mentioned above, the reinforcement post 24 is secured to the frame post 22 with fasteners 34. In this embodiment, fasteners 34 are rivets, however those of skill in the art will appreciate that any suitable fasteners, such as bolts, for example, may be used. The use of fasteners 34 allows the reinforcement post 24 to be secured to frame post 22 in a facile manner, and eliminates the need for the welding of reinforcement post 24 to frame post 22. As will be appreciated, this generally simplifies the assembly of the pallet rack frame 20, and also provides versatility in that it allows reinforcement posts to be incorporated into the pallet rack frame 20 either prior to shipping or at the installation site. This allows the reinforcement post 24 to be secured to the frame post 22 during initial assembly, or to be retro-fitted to the frame post 22 of an assembled pallet rack frame 20, for example.

In this embodiment, the reinforcement post 24 is fabricated from roll formed steel and has a generally “C-shaped” cross sectional profile, defining first and second arms 42 and 44, respectively, joined by a web 46. Each of the arms 42 and 44 has a rib 48 protruding outwardly therefrom intermediate its ends that extends generally the length of the reinforcement post 24. The portion of each arm 42 and 44 between web 46 and protruding rib 48 is perforated with a series of generally equally spaced apertures 53, which allows reinforcement post 24 to be secured to frame post 22 with fasteners 34. The free distal end of each arm 42 and 44 is terminated by a flared end 52. The portion of each arm 42 and 44 between protruding rib 48 and the flared end 52 is also perforated with a series of equally spaced apertures 54, which allows braces 26 and 28 to be secured to reinforcement post 24 with fasteners 36. In the embodiment shown, fasteners 36 are bolts, however those of skill in the art will appreciate that any suitable fasteners, such as rivets, for example, may be used.

Similar to reinforcement post 24, frame post 22 is also fabricated from roll formed steel and has a generally “C-shaped” cross sectional profile, defining first and second arms 62 and 64, respectively, joined by a web 66. Web 66 is perforated with a series of generally equally spaced apertures, which allow load beams 23 to be connected to the frame post 22. Each of the arms 62 and 64 is shaped to define a recess 68 intermediate its ends that extends generally the length of the frame post 22. The free distal end of each of the arms 62 and 64 is terminated by a flared end 72. The recess 68 of each arm 62 and 64 is also perforated with a series of equally spaced apertures.

As is best illustrated in FIG. 5, reinforcement post 24 is shaped and sized to be received between the arms 62 and 64 of its associated frame post 22 so that the reinforcement post 24 partially rests in the frame post 22. More specifically, the open end of frame post 22 is shaped to accomodate the portion of reinforcement post 24 that lies between web 46 and the inclined surfaces 56 of ribs 48, in such a manner that surfaces 56 of the ribs 48 abut against the flared ends 72 of frame post 22, and the outer surfaces of arms 42 and 44 of reinforcement post 24 interface (i.e. are in contact with) the inner surfaces of the recesses 68 to bring the spaced apertures in the recesses 68 into alignment with the spaced apertures 53 in the arms 42 and 44.

Reinforcement post 24 is itself shaped to optionally accomodate an adjacent reinforcement post 24 in its open end. More specifically, the spacing between the inner surfaces of arms 42 and 44 adjacent flared ends 52 is generally commensurate with the distance between the outer surfaces of arms 42 and 44 proximate web 46. This geometry enables the open end of a first reinforcement post 24 to accomodate the closed end of a second reinforcement post 24, and in such a manner that rib surfaces 56 of the second reinforcement post 24 abut against the flared ends 52 of the first reinforcement post 24, and where the outer surfaces of sides 42 and 44 of the second reinforcement post 24 are in contact with the inner surfaces of the sides 42 and 44 of the first frame post 24. In this manner, the apertures 54 of the first reinforcement post 24 are brought into alignment with the apertures 53 of the second reinforcement post 24, allowing the two reinforcement posts 24 to be secured to each other using suitable fasteners. Two or more reinforcement posts 24 can thereby be secured to a single frame post 22, providing increased reinforcement as desired.

As will be appreciated, the shape of reinforcement post 24 provides several structural advantages over prior art reinforcement posts. For example, ribs 48 provide reinforcement post 24 with greater torsional strength than other posts of similar gauge but having more basic cross sectional profiles, such as a flat-walled tube, for example. Additionally, reinforcement post 24 engages frame post 22 by interfacing the surfaces of arms 42 and 44 with the inner surfaces of recesses 68, and by engaging the surfaces 56 of ribs 48 with the flared ends 72. This interfacial area between the frame post 22 and the reinforcement post 24 is significantly greater than what might otherwise be obtained between two frame posts welded together in a “doubled up” configuration. Indeed, the interfacial area of such a “doubled up” configuration would comprise only the areas of the weld interfaces between the “doubled up” posts. Additionally, the use of base plate 30 having larger area than what might otherwise be used with frame post 22 alone, or with a prior art frame post having a reinforcement post fully enclosed within, allows loads to be distributed over a larger area.

From a manufacturing standpoint, reinforcement post 24 affords a number of advantages over welded pallet rack frame post reinforcements of the prior art. For example, reinforcement post 24 may be fabricated as a stock part, which reduces the costs of reinforcing pallet rack frames and which may also be easily incorporated into pallet rack frame design programs. Reinforcement post 24 is compatible with “bolted” pallet rack systems, and may be secured to the pallet rack frame using the same tools and fasteners as those used for the assembly of the remainder of the pallet rack frame. Reinforcement post 24 can also be easily added in the field to an already-assembled pallet rack frame, for providing reinforcement as needed or as desired. Such reinforcement may be for any purpose, such as increasing the capacity of the pallet rack frame, increasing the resistance to lateral impacts, and restoring the structural integrity of a damaged post. Moreover, as welding is not relied upon for securing the reinforcement post to the pallet rack frame post, the addition of the reinforcement post may be carried out using non-skilled labour and standard hardware, which lowers the cost of ownership of the pallet rack frame.

Those of skill in the art will appreciate that the reinforcement post is not limited to the cross sectional profile of the embodiments described above, and in other embodiments the reinforcement post may have other cross sectional profiles.

Although embodiments have been described above with reference to the accompanying drawings, those of skill in the art will appreciate that variations and modifications may be made without departing from the spirit and scope thereof as defined by the appended claims.

1. A reinforcement post for a pallet rack frame, the reinforcement post being configured to be secured to a pallet rack frame post with fasteners.

2. The reinforcement post of claim 1, wherein the reinforcement post is further configured for having at least one component of the pallet rack frame secured thereto.

3. The reinforcement post of claim 2, wherein the at least one component of the pallet rack frame is a brace.

4. The reinforcement post of claim 1, wherein the reinforcement post comprises a web joining two arms, each arm having a rib at an intermediate position along the arm and protruding outwardly therefrom, the rib generally extending the length of the reinforcement post.

5. The reinforcement post of claim 4, wherein a portion of the reinforcement post between the web and the ribs is sized to be received between arms of the pallet rack frame post.

6. The reinforcement post of claim 5, wherein spacing between the arms of the reinforcement post is sized to receive the portion of an adjacent reinforcement post.

7. The reinforcement post of claim 1 wherein the fasteners comprise at least one of rivets and bolts.

8. Use of the reinforcement post of claim 1 with the pallet rack frame.

9. A pallet rack frame comprising
a plurality of pallet rack frame posts;
a plurality of load beams connected to the frame posts for providing horizontal support of palletized loads; and
at least one reinforcement post secured to a respective frame post with fasteners, the reinforcement post providing reinforcement to the frame post when secured thereto.

10. The pallet rack frame of claim 9, wherein the reinforcement post is configured for having at least one component of the pallet rack frame secured thereto.

11. The pallet rack frame of claim 10, wherein the at least one component of the pallet rack frame is a brace.

12. The pallet rack frame of claim 9, wherein the reinforcement post comprises a web joining two arms, each arm having a rib at an intermediate position along the arm and protruding outwardly therefrom, the rib generally extending the length of the reinforcement post.

13. The pallet rack frame of claim 12, wherein a portion of the reinforcement post between the web and the ribs is sized to be received between arms of the pallet rack frame post.

14. The pallet rack frame of claim 13, wherein spacing between the arms of the reinforcement post is sized to receive the portion of an adjacent reinforcement post.

15. The pallet rack frame of claim 9 wherein the fasteners comprise at least one of rivets and bolts.

16. A method of providing reinforcement for a pallet rack frame post comprising securing a reinforcement post to the frame post with fasteners.

17. The method of claim 16, whereby the reinforcement post is configured for having at least one component of the pallet rack frame secured thereto.

18. The method of claim 17, whereby the at least one component of the pallet rack frame is a brace.

19. The method of claim 16, wherein the reinforcement post comprises a web joining two arms, each arm having a rib at an intermediate position along the arm and protruding outwardly therefrom, the rib generally extending the length of the reinforcement post.

20. The method of claim 19, wherein a portion of the reinforcement post between the web and the ribs is sized to be received between arms of the pallet rack frame post.

21. The method of claim 20, wherein spacing between the arms of the reinforcement post is sized to receive the portion of an adjacent reinforcement post.

22. The method of claim 16, whereby the fasteners comprise at least one of rivets and bolts.
